(19) United States
(12) Patent Application Publication
(10) Pub. No.: US 2014/0041233 A1
(43) Pub. Date: Feb. 13, 2014

(54) Small-sized hair trimming device

(71) Applicant: Tung Yan LAU, GUANGDONG PROVINCE (CN)

(72) Inventor: Tung Yan LAU, GUANGDONG PROVINCE (CN)

(21) Appl. No.: 13/944,897

(22) Filed: Jul. 18, 2013

(30) Foreign Application Priority Data
Aug. 10, 2012 (CN) 201220395162.6

(51) Int. Cl. B26B 19/14

(52) U.S. Cl. CPC B26B 19/148
USPC 30/29.5

(57) ABSTRACT

A small-sized hair trimming device comprising a fixed trimming block and a movable trimming block, both longitudinally, linearly and alternately arranged with multiple openings and teeth; the movable trimming block is sleeved within the fixed trimming block and movable in reciprocate movement with respect to the fixed trimming block; inner portions of the fixed trimming block teeth correspond to outer portions of the movable trimming block teeth in terms of shape and dimension, and gap does not exist in between the fixed trimming block and the movable trimming block when they meet with each other, thereby forming a trimming surface for trimming hair; the said trimming surface is concealed between the fixed trimming block and the movable trimming block without exposing to exterior environment; the small-sized hair trimming device is safe and convenient to use, and it has a reasonable structure and a bigger trimming surface.

### BACKGROUND OF THE INVENTION

The present invention relates to the field of personal care product, and more specifically relates to a kind of small-sized hair trimming device.

In general, there are two types of hair trimming device available in the market, one type using oscillating blades and the other type using rotary blades. A novel hair trimming device that uses rotary blades for trimming hair on the face trims nasal hair or ear hair using a set of small-sized rotary blades which are protected inside a stainless steel cover at an outer casing of a head of the novel hair trimming device. The stainless steel cover can prevent the blades from direct contact with nasal or ear canal interior of the user so as to ensure safety use of the novel hair trimming device. A novel hair trimming device that uses oscillating blades for trimming hair on the face comprises a toothed movable blade and a toothed fixed blade disposed at an upper end of an outer casing of the novel hair trimming device. Teeth of the movable blade and teeth of the fixed blade can cooperate with one another so as to define a trimming surface perpendicular to an axis of the user's nasal cavity or ear canal. The two types of novel hair trimming device for trimming hair on the face as described above can trim hair, but their hair trimming efficiency is low due to relatively small trimming surface.

Furthermore, both types as described above require users to remove the blades for cleaning and drying after use. If the blades are not dried thoroughly, they will rust easily due to prolonged contact with water. As a result, service life of the blades will be shortened. Some products now available in the market are complicated in their structure, trouble to disassemble and also trouble to assemble again after cleaning. Some other products are designed such that only their blades can be removed for cleaning while other parts are not designed as waterproof. As a result, water penetration into the products may result in electrical fault.

### BRIEF SUMMARY OF THE INVENTION

In view of the aforesaid disadvantages now present in the prior art, the present invention provides a kind of small-sized hair trimming device which is safe and convenient to use and can be cleaned easily.

The present invention adopts the following technical proposal:

A small-sized hair trimming device comprises a fixed trimming block and a movable trimming block; top section of the fixed trimming block is longitudinally, linearly and alternately arranged with multiple openings and teeth; top section of the movable trimming block is also longitudinally, linearly and alternately arranged with multiple openings and teeth; the movable trimming block is sleeved within the fixed trimming block and can move in reciprocate movement with respect to the fixed trimming block; inner portions of the fixed trimming block teeth correspond to outer portions of the movable trimming block teeth in terms of shape and dimension; when the fixed trimming block teeth and the movable trimming block teeth meet with one another, gap does not exist in between the fixed trimming block teeth and the movable trimming block teeth, thereby forming a trimming surface for trimming hair; the said trimming surface is concealed between the fixed trimming block and the movable trimming block; the said trimming surface does not expose to exterior environment.

The top section of the fixed trimming block comprises a left teeth section and a right teeth section; the left and right teeth sections are each constituted by a blade provided with teeth; edges of two sides of an inner surface of each of the teeth are cutting edges; the teeth of the left teeth section and the teeth of the right teeth section close inwardly towards one another; a tooth peak is formed at each intersection point between a top end of each of the teeth of the left teeth section and a top end of each corresponding teeth of the right teeth section, thus forming the teeth having an arc shaped, inverted V-shaped or trapezium shaped cross section at the top section of the fixed trimming block.

The top section of the movable trimming block comprises another left teeth section and another right teeth section; the left and right teeth sections are each constituted by a blade provided with teeth; edges of two sides of an outer surface of each of the teeth are cutting edges; the teeth of the left teeth section and the teeth of the right teeth section close inwardly towards one another; a tooth peak is formed at each intersection point between a top end of each of the teeth of the left teeth section and a top end of each corresponding teeth of the right teeth section; thus forming the teeth having an arc shaped, inverted V-shaped or trapezium shaped cross section at the top section of the movable trimming block, whereas the top section of the movable trimming block matches with the the top section of the fixed trimming block.

Top ends of the blades of the left and right teeth sections of the fixed trimming block bend slightly inward to form a smooth outer surface; correspondingly, top ends of the blades of the left and right teeth sections of the movable trimming block also bend slightly inward, so that gap does not exist when the inner portions of the teeth of the fixed trimming block meet with the outer portions of the teeth of the movable trimming block.

An outer surface of a top section of each of the teeth of the fixed trimming block has an arc-shaped cross section; cross section of an inner surface of each tooth peak of the fixed trimming block and cross section of a corresponding outer surface of each tooth peak of the movable trimming block are both in the shape of an arc matching with each other in terms of shape and dimension; the cross section of the inner surface of each tooth peak of the fixed trimming block and the cross section of the corresponding outer surface of each tooth peak of the movable trimming block are in arc shape, inverted V shape or trapezium shape matching with each other in terms of shape and dimension.

The small-sized hair trimming device also comprises an outer case; the outer case has an interior divided into a front cavity and a rear cavity separated in a way that water is not penetrable between them; the movable trimming block and the fixed trimming block are disposed inside the front cavity; the movable trimming block is connected with a motion transmission rod which have one end extended into the rear cavity to connect with a motion generating mechanism; a cavity is formed in an interior space formed by the movable trimming block for collecting hair being cut away; drainage openings are provided on the cavity.

An end of the outer case is an elongated portion disposed with a trough; the fixed trimming block is removably mounted on the trough; outer surface of the fixed trimming block and the elongated portion match with each other in terms of shape.

In between the fixed trimming block and a corresponding bottom surface on the trough of the elongated portion, there is a flexible pressing piece for pressing and securing the fixed trimming block inside the trough; an end of the elongated portion is provided with a water inlet; the drainage openings are provided on a surface of the elongated portion under the flexible pressing piece.

The front cavity and the rear cavity are separated by a separation panel; portion of the motion transmission rod extending through the separation panel matches and connects with opening of the separation panel; seal ring is disposed between the front cavity and the rear cavity.

The elongated portion has a triangular cross section.

Compared with the prior art, the present invention has the following advantages:

The present invention is safe and convenient to use, and it has a reasonable structure and a bigger trimming surface.

### BRIEF DESCRIPTION OF THE DRAWINGS

FIG. 1 illustrates part of the present invention according an embodiment.

FIG. 2 is an exploded view of part of the present invention according to an embodiment.

FIG. 3 is an enlarged view of a part of FIG. 2.

FIG. 4 is an assembled view of a movable trimming block and a motion transmission rod of the present invention according to an embodiment.

FIG. 5 is a sectional view illustrating a condition where a movable trimming block is sleeved within a fixed trimming block according an embodiment of the present invention.

FIG. 6 is another exploded view of part of the present invention according to an embodiment.

FIG. 7 is yet another exploded view of part of the present invention according to an embodiment.

FIG. 8 is still yet another exploded view of part of the present invention according to an embodiment.

### DETAILED DESCRIPTION OF THE INVENTION

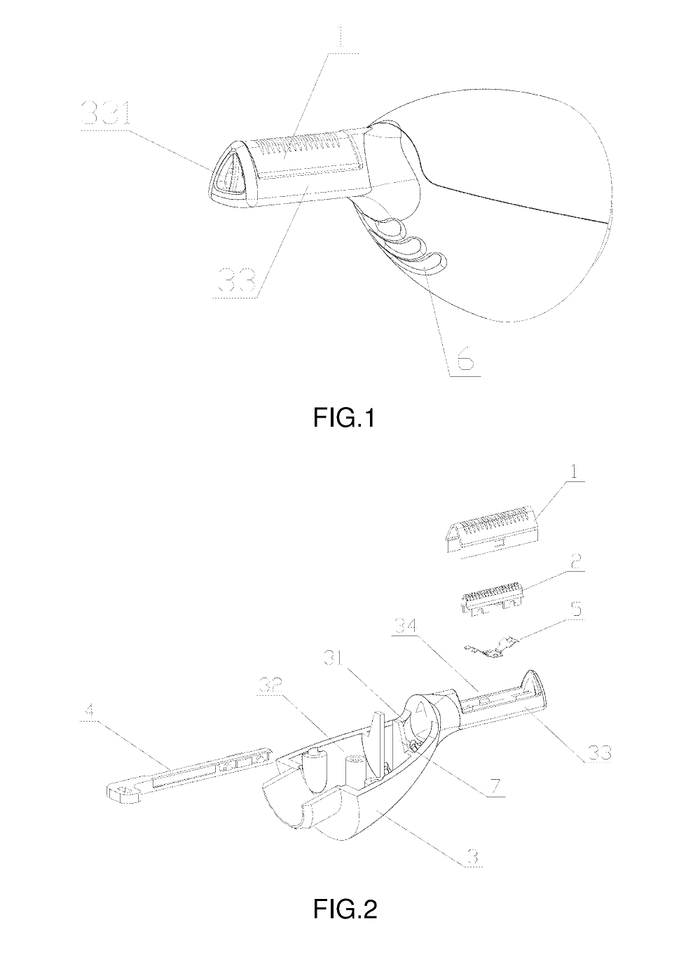

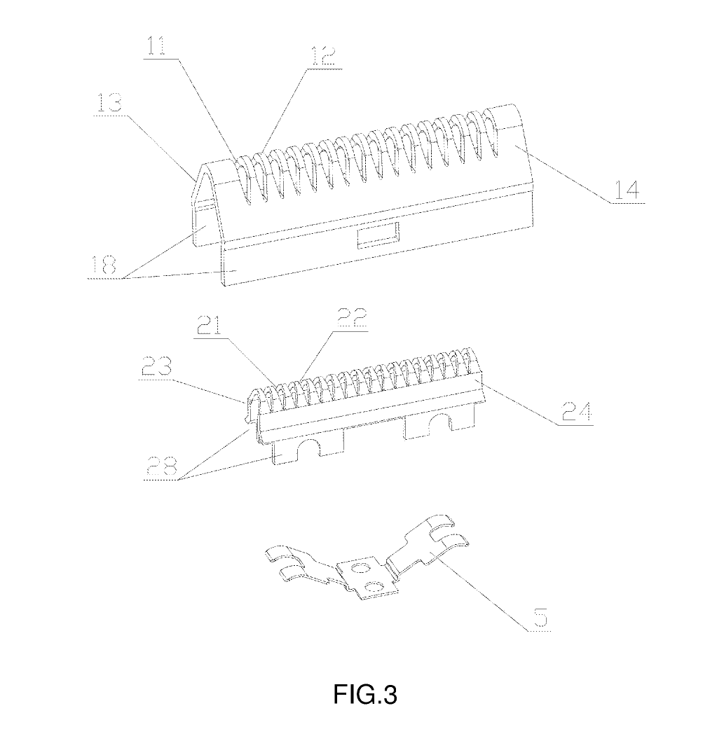

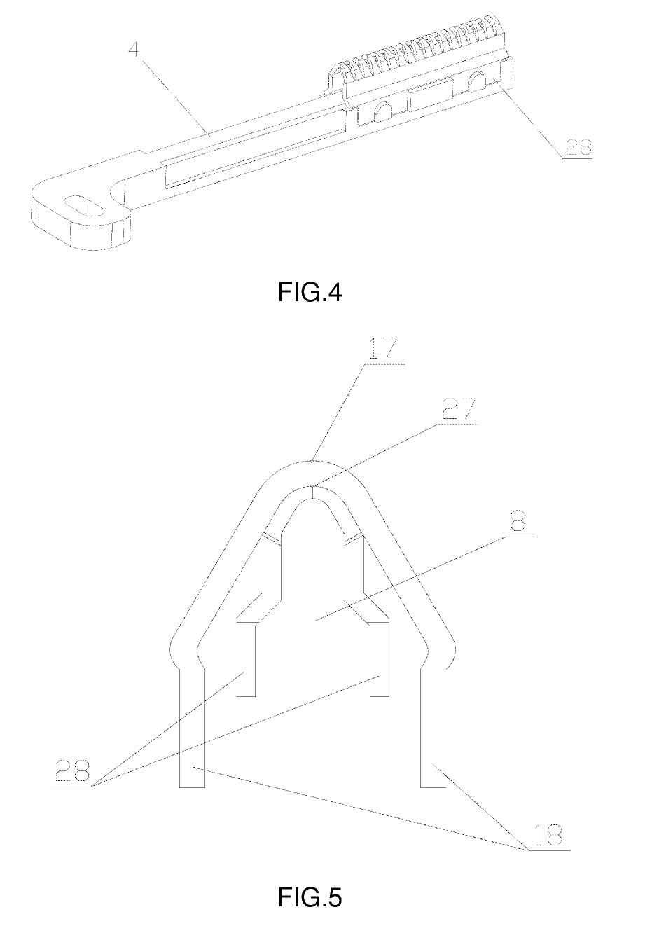

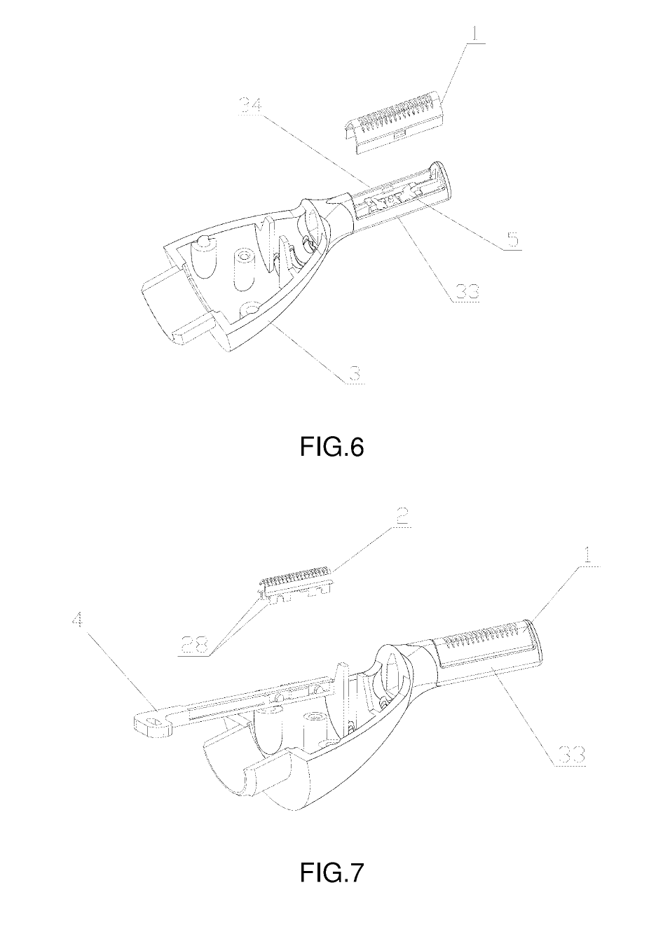

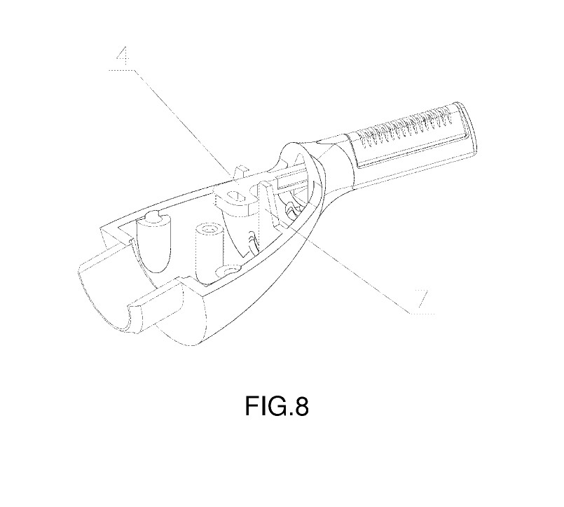

As shown in FIGS. 1-8, a small-sized hair trimming device according to the present embodiment comprises a fixed trimming block 1 and a movable trimming block 2. Top section of the fixed trimming block 1 is longitudinally, linearly and alternately arranged with multiple openings 11 and teeth 12. Top section of the movable trimming block 2 is also longitudinally, linearly and alternately arranged with multiple openings 21 and teeth 22. The movable trimming block 2 is sleeved within the fixed trimming block 1 and can move in reciprocate movement with respect to the fixed trimming block 1. Inner portions of the fixed trimming block teeth 12 correspond to outer portions of the movable trimming block teeth 22 in terms of shape and dimension. When the fixed trimming block teeth 12 and the movable trimming block teeth 22 meet with one another, gap does not exist in between the fixed trimming block teeth 12 and the movable trimming block teeth 22, thereby forming a trimming surface for trimming hair. The said trimming surface is concealed between the fixed trimming block 1 and the movable trimming block 2. The said trimming surface does not expose to exterior environment.

The top section of the fixed trimming block 1 comprises a left teeth section 13 and a right teeth section 14. The left and right teeth sections 13, 14 are each constituted by a blade provided with teeth 15. Edges of two sides of an inner surface of each of the teeth 15 are cutting edges. The teeth 15 of the left teeth section 13 and the teeth 15 of the right teeth section 14 are correspondingly and symmetrically arranged with respect to one another in terms of dimension and position and close inwardly towards one another. A tooth peak 17 is formed at each intersection point between a top end of each of the teeth 15 of the left teeth section 13 and a top end of each corresponding teeth 15 of the right teeth section 14. As a result, the said teeth 12 having an inverted V-shaped cross section are formed at the top section of the fixed trimming block 1.

The top section of the movable trimming block 2 comprises another left teeth section 23 and another right teeth section 24. The left and right teeth sections 23, 24 are each constituted by a blade provided with teeth 25. Edges of two sides of an outer surface of each of the teeth 25 are cutting edges. The teeth 25 of the left teeth section 23 and the teeth 25 of the right teeth section 24 close inwardly towards one another. A tooth peak 27 is formed at each intersection point between a top end of each of the teeth 25 of the left teeth section 23 and a top end of each corresponding teeth 25 of the right teeth section 24. As a result, the said teeth 22 having an inverted V-shaped cross section are formed at the top section of the movable trimming block 2.

To prevent cuts on user's skin, top ends of the blades of the left and right teeth sections 13, 14 of the fixed trimming block 1 bend slightly inward to form a smooth outer surface. Correspondingly, top ends of the blades of the left and right teeth sections 23, 24 of the movable trimming block 2 also bend slightly inward, so that gap does not exist when the inner portions of the teeth 12 of the fixed trimming block 1 meet with the outer portions of the teeth 22 of the movable trimming block 2.

An outer surface of a top section of each of the teeth 12 of the fixed trimming block 1 has an arc-shaped cross section. Cross section of an inner surface of each tooth peak 17 of the fixed trimming block 1 and cross section of a corresponding outer surface of each tooth peak 27 of the movable trimming block 2 are both in the shape of an arc and the two arcs match and correspond to each other in terms of shape and dimension.

The small-sized hair trimming device also comprises an outer case 3. The outer case 3 has an interior divided into a front cavity 31 and a rear cavity 32 separated in a way that water is not penetrable between them. The movable trimming block 2 and the fixed trimming block 1 are disposed inside the front cavity 31. The movable trimming block 2 is connected with a first end of a motion transmission rod 4. A second end of the motion transmission rod 4 extends into the rear cavity 32 to connect with a motion generating mechanism. A cavity 8 is formed in an interior space formed by the movable trimming block 2 for collecting hair being cut away. Drainage openings 6 are provided on the cavity 8 so that water allowed inside the front cavity 31 during cleaning can be discharged out of the outer case 3.

An end of the outer case 3 is an elongated portion 33 disposed with a trough 34. The fixed trimming block 1 is removably mounted on the trough 34. Outer surface of the fixed trimming block 1 and the elongated portion 33 match with each other in terms of shape. In between the fixed trimming block 1 and a corresponding bottom surface on the trough 34 of the elongated portion 33, there is a flexible pressing piece 5 for pressing and securing the fixed trimming block 1 inside the trough 34. An end of the elongated portion 33 is provided with a water inlet 331 for easier cleaning. The drainage openings 6 are provided on a surface of the elongated portion 33 under the flexible pressing piece 5.

According to the present embodiment, the front cavity 31 and the rear cavity 32 are separated by a separation panel 7. Portion of the motion transmission rod 4 extending through the separation panel 7 matches and connects with opening of the separation panel 7. In order to strengthen sealing effect, seal ring may be disposed between the front cavity and the rear cavity so that while the motion transmission rod 4 is enabled to move in reciprocate movement along the opening of the separation panel, the front cavity and the rear cavity are also sealed such that water cannot enter the rear cavity 32 during cleaning.

The fixed trimming block 1 also comprises a vertical and parallel left and right base 18 connected with the left and right teeth sections 13, 14. The fixed trimming block connects with the elongated portion 33 via the left and right base 18. The movable trimming block 2 also comprises a vertical and parallel left and right base 28 connected with the left and right teeth sections 23, 24. The movable trimming block 2 is connected and fixed with the first end of the motion transmission rod 4 via the left and right base 28.

Apart from the elongated portion 33, other parts of the outer case 3 can be designed with an enlarged outer diameter so that hair being cut away accumulates in the front cavity 31 along an arc-shaped inner surface of the outer case and can be easily washed away during cleaning. The drainage openings 6 may have a hole shape, an arc shape or a bar shape.

The cross section of the inner surface of each tooth peak 17 of the fixed trimming block 1 and the cross section of the corresponding outer surface of each tooth peak 27 of the movable trimming block 2 are not restricted to arcs which match and correspond to each other in terms of shape and dimension. They may be trapeziums, inverted V shapes or depressed arcs matching and corresponding to each other in terms of shape and dimension. Also, since an outer top part of each of the tooth peaks 17, 27 is not required to perform trimming function, the cross section of the inner surface of each tooth peak 17 of the fixed trimming block 1 and the cross section of the corresponding outer surface of each tooth peak 27 of the movable trimming block 2 is not required to match with each other. For example, the cross section of the inner surface of each tooth peak 17 of the fixed trimming block 1 may have an arc shape while the cross section of the corresponding outer surface of each tooth peak 27 of the movable trimming block 2 may have a trapezium shape, an inverted V shape or a depressed arc shape.

The above embodiments described in greater detail are only a few embodiments of the present invention and should not limit the scope of the present invention. To any person skilled in this field of art, any change and modification without deviating from the concept of the present invention should also fall within the scope of protection of the present invention. The scope of protection of the present invention should be limited by the Claims.

What is claimed is:

1. A small-sized hair trimming device comprising a fixed trimming block 1 and a movable trimming block 2, wherein top section of the fixed trimming block 1 is longitudinally, linearly and alternately arranged with multiple openings 11 and teeth 12; top section of the movable trimming block 2 is also longitudinally, linearly and alternately arranged with second set of multiple openings 21 and second set of teeth 22; the movable trimming block 2 is sleeved within the fixed trimming block 1 and can move in reciprocate movement with respect to the fixed trimming block 1; inner portions of the teeth 12 correspond to outer portions of the second set of teeth 22 in terms of shape and dimension; when the teeth 12 and the second set of teeth 22 meet with one another, gap does not exist in between the teeth 12 and the second set of teeth 22, thereby forming a trimming surface for trimming hair; the said trimming surface is concealed between the fixed trimming block 1 and the movable trimming block 2; the said trimming surface does not expose to exterior environment.

2. The small-sized hair trimming device as in claim 1, wherein the top section of the fixed trimming block 1 comprises a left teeth section 13 and a right teeth section 14; the left and right teeth sections 13,14 are each constituted by a blade provided with a third set of teeth 15; edges of two sides of an inner surface of each of the third set of teeth 15 are cutting edges; the third set of teeth 15 of the left teeth section 13 and the third set of teeth 15 of the right teeth section 14 close inwardly towards one another; a tooth peak 17 is formed at each intersection point between a top end of each of the third set of teeth 15 of the left teeth section 13 and a top end of each corresponding third set of teeth 15 of the right teeth section 14, thus forming the teeth 12 having an arc shaped, inverted V-shaped or trapezium shaped cross section at the top section of the fixed trimming block 1.

3. The small-sized hair trimming device as in claim 2, wherein the top section of the movable trimming block 2 comprises another left teeth section 23 and another right teeth section 24; the said another left and right teeth sections 23, 24 are each constituted by another blade provided with a fourth set of teeth 25;
edges of two sides of an outer surface of each of the fourth set of teeth 25 are cutting edges; the fourth set of teeth 25 of the left teeth section 23 and the fourth set of teeth 25 of the right teeth section 24 close inwardly towards one another; a second tooth peak 27 is formed at each intersection point between a top end of each of the fourth set of teeth 25 of the said another left teeth section 23 and a top end of each corresponding fourth set of teeth 25 of the said another right teeth section 24; thus forming the second set of teeth 22 having an arc shaped, inverted V-shaped or trapezium shaped cross section at the top section of the movable trimming block 2, whereas the top section of the movable trimming block 2 matches with the top section of the fixed trimming block 1.

4. The small-sized hair trimming device as in claim 3, wherein top ends of the blades of the left and right teeth sections 13, 14 of the fixed trimming block 1 bend slightly inward to form a smooth outer surface; correspondingly, top ends of the said another blades of the said another left and right teeth sections 23, 24 of the movable trimming block 2 also bend slightly inward, so that gap does not exist when the inner portions of the teeth 12 of the fixed trimming block 1 meet with the outer portions of the second set of teeth 22 of the movable trimming block 2.

5. The small-sized hair trimming device as in claim 1, wherein an outer surface of a top section of each of the teeth 12 of the fixed trimming block 1 has an arc-shaped cross section; cross section of an inner surface of each tooth peak 17 of the fixed trimming block 1 and cross section of a corresponding outer surface of each another tooth peak 27 of the movable trimming block 2 are both in the shape of an arc matching with each other in terms of shape and dimension; the cross section of the inner surface of each tooth peak 17 of the fixed trimming block 1 and the cross section of the corresponding outer surface of each another tooth peak 27 of the movable trimming block 2 are in arc shape, inverted V shape or trapezium shape matching with each other in terms of shape and dimension.

6. The small-sized hair trimming device as in claim 1, wherein the small-sized hair trimming device also comprises an outer case 3; the outer case 3 has an interior divided into a front cavity 31 and a rear cavity 32 separated in a way that water is not penetrable between them; the movable trimming block 2 and the fixed trimming block 1 are disposed inside the front cavity 31; the movable trimming block 2 is connected with a motion transmission rod 4 which have one end extended into the rear cavity 32 to connect with a motion generating mechanism; a cavity 8 is formed in an interior space formed by the movable trimming block 2 for collecting hair being cut away; drainage openings 6 are provided on the cavity 8.

7. The small-sized hair trimming device as in claim 6, wherein an end of the outer case 3 is an elongated portion 33 disposed with a trough 34; the fixed trimming block 1 is removably mounted on the trough 34; outer surface of the fixed trimming block 1 and the elongated portion 33 match with each other in terms of shape.

8. The small-sized hair trimming device as in claim 7, wherein a flexible pressing piece 5 for pressing and securing the fixed trimming block 1 inside the trough 34 is provided in between the fixed trimming block 1 and a corresponding bottom surface on the trough 34 of the elongated portion 33;
an end of the elongated portion 33 is provided with a water inlet 331; the drainage openings 6 are provided on a surface of the elongated portion 33 under the flexible pressing piece 5.

9. The small-sized hair trimming device as in claim 6, wherein the front cavity 31 and the rear cavity 32 are separated by a separation panel 7; portion of the motion transmission rod 4 extending through the separation panel 7 matches and connects with opening of the separation panel 7; seal ring is disposed between the front cavity 31 and the rear cavity 32.

10. The small-sized hair trimming device as in claim 6, wherein the elongated portion 33 has a triangular cross section.
